(19) United States
(12) Patent Application Publication
(10) Pub. No.: US 2017/0168885 A1
(43) Pub. Date: Jun. 15, 2017

(54) System and Method for Testing Internet of Things Network

(71) Applicant: HCL Technologies Limited, Uttar Pradesh (IN)

(72) Inventors: Parveen Kumar Jain, Noida (IN); Vivek Rangi, Noida (IN); Abhay Mishra, Noida (IN); S U M Prasad Dhanyamraju, Hyderabad (IN)

(21) Appl. No.: 15/361,880

(22) Filed: Nov. 28, 2016

(30) Foreign Application Priority Data
Dec. 9, 2015 (IN) 4013/DEL/2015

(51) Int. Cl. G06F 11/07

(52) U.S. Cl. CPC G06F 11/079; G06F 11/0709

(57) ABSTRACT

The present disclosure relates to system(s) and method(s) for generating test data for testing an Internet of Things (IOT) network. Initially, the system is configured for receiving sensor ontology data of at least one sensor to be simulated for testing an Internet of things (IOT) network. The sensor ontology data may include a range of operation of the sensor and a frequency of operation of the sensor. Further, the system is configured for accepting a set of test scenarios for testing the IOT network. Furthermore, the system is configured for generating master test data for testing the IOT network, wherein the master test data comprises a set of test packages corresponding to the set of test scenario and the sensor ontology data.

### CROSS-REFERENCE TO RELATED APPLICATIONS AND PRIORITY

The present application claims benefit from Indian Complete Patent Application No. 4013/DEL/2015, filed on Dec. 09, 2015, the entirety of which is hereby incorporated by reference.

### TECHNICAL FIELD

The present disclosure in general relates to the field of testing Internet of Things (IOT) network. More particularly, the present invention relates to a system and method for generating test data to test IOT network.

### BACKGROUND

Framework development is an initial stage in Internet of Things (IoT) network development. Nowadays, there is a wide range of smart devices produced that from different structures to be induced in the IOT network. These smart devices are heterogeneous in nature. The heterogeneous nature of these smart devices is generally defined using ontology such as Semantic Sensor Network (SSN).

Testing of such IOT networks is an essential stage in software development for the IOT network. The major processes involved in testing IOT networks are test data generation, test execution and monitoring. Due to the involvement of these processes, it makes testing an expensive process. Although much of the testing processes are automated by modern software development environments (e.g., test execution, monitoring), the process of generating test data is still a manual process. The process of generating test data from actual smart devices in IOT network involves a lot of cost, computation and human intervention.

For the purpose of generating test data, every smart device in the IOT network is configured to keep on sensing sensor data on continuous bases. The sensor data is then stored at cloud storage or data lake. The stored sensor data is then used for testing and monitoring the IOT network. This process of generating test data is very expensive in terms of time and required resources. The problem of test data generation becomes more and more critical when voluminous data is to be generated within realistic time for a variety of connected smart devices, where the generated test data should satisfy certain criteria/test goals. Simultaneously sending the test data to large-scale data processing platform/environment for testing IOT network is also a challenge.

### SUMMARY

This summary is provided to introduce aspects related to systems and methods for testing of IOT network and the aspects are further described below in the detailed description. This summary is not intended to identify essential features of the claimed subject matter nor is it intended for use in determining or limiting the scope of the claimed subject matter.

In one embodiment, a system for generating test data for testing an Internet of Things (IOT) network is illustrated. The system comprises a processor coupled to a memory, wherein the processor is configured to execute programmed instructions stored in the memory. The processor may execute a programmed instruction for receiving sensor ontology data of at least one sensor to be simulated for testing an Internet of things (IOT) network. The sensor ontology data may include a range of operation of the sensor and a frequency of operation of the sensor. The processor may execute a programmed instruction for defining a range of normal operation of sensor and a range of abnormal operation of sensor from the range of operation of the sensor. The processor may execute a programmed instruction for defining a frequency of normal operation of the sensor, and a frequency of abnormal operation of the sensor from the frequency of operation of the sensor. Further, the processor may execute a programmed instruction for generating, a first test data and a second test data. The first test data is generated by randomly selecting values between the range of normal operation of the sensor and the second test data is generated by randomly selecting values between the range of abnormal operation of the sensor. Further, the processor may execute a programmed instruction for accepting a set of test scenarios for testing the IOT network. Furthermore, the processor may execute a programmed instruction for generating master test data for testing the IOT network, wherein the master test data comprises a set of test packages corresponding to the set of test scenario. Each test package is generated by selecting values from the first test data and the second test data, based on the frequency of normal operation of the sensor and the frequency of abnormal operation of the sensor respectively corresponding to the test scenario.

In one embodiment, a method for generating test data for testing an Internet of Things (IOT) network is illustrated. The method may comprise receiving sensor ontology data of at least one sensor to be simulated for testing an Internet of things (IOT) network. The sensor ontology data may include a range of operation of the sensor and a frequency of operation of the sensor. The method may further comprise defining a range of normal operation of sensor and a range of abnormal operation of sensor from the range of operation of the sensor. The method may further comprise defining a frequency of normal operation of the sensor, and a frequency of abnormal operation of the sensor from the frequency of operation of the sensor. The method may further comprise generating, a first test data and a second test data. The first test data is generated by randomly selecting values between the range of normal operation of the sensor and the second test data is generated by randomly selecting values between the range of abnormal operation of the sensor. The method may further comprise accepting a set of test scenarios for testing the IOT network. The method may further comprise generating master test data for testing the IOT network, wherein the master test data comprises a set of test packages corresponding to the set of test scenario. Each test package is generated by selecting values from the first test data and the second test data, based on the frequency of normal operation of the sensor and the frequency of abnormal operation of the sensor respectively corresponding to the test scenario. In an embodiment, the aforementioned method may be executed by a processor using programmed instructions stored in a memory coupled with the processor.

In one embodiment, a non-transitory computer readable medium embodying a program executable in a computing device for generating test data to test an Internet of Things (IOT) network, is disclosed. The program comprises a program code for receiving sensor ontology data of at least one sensor to be simulated for testing an Internet of things (IOT) network. The sensor ontology data may include a range of operation of the sensor and a frequency of operation of the sensor. The program comprises a program code for defining a range of normal operation of sensor and a range of abnormal operation of sensor from the range of operation of the sensor. The program comprises a program code for defining a frequency of normal operation of the sensor, and a frequency of abnormal operation of the sensor from the frequency of operation of the sensor. The program comprises a program code for generating, a first test data and a second test data. The first test data is generated by randomly selecting values between the range of normal operation of the sensor and the second test data is generated by randomly selecting values between the range of abnormal operation of the sensor. The program comprises a program code for accepting a set of test scenarios for testing the IOT network. The program comprises a program code for generating master test data for testing the IOT network, wherein the master test data comprises a set of test packages corresponding to the set of test scenario. Each test package is generated by selecting values from the first test data and the second test data, based on the frequency of normal operation of the sensor and the frequency of abnormal operation of the sensor respectively corresponding to the test scenario.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for generating test data to test an Internet of Things (IOT) network, in accordance with an embodiment of the present subject matter.

FIG. 2 illustrates the system for generating test data to test the Internet of Things (IOT) network, in accordance with an embodiment of the present subject matter.

FIG. 3 illustrates a flow diagram for generating test data using the system, in accordance with an embodiment of the present subject matter.

### DETAILED DESCRIPTION

The present subject matter relates to a system for generating test data for testing an Internet of Things (IOT) network. Initially, the system is configured for receiving sensor ontology data of at least one sensor to be simulated for testing an Internet of things (IOT) network. The sensor ontology data may include a range of operation of the sensor and a frequency of operation of the sensor. The system may define a range of normal operation of sensor and a range of abnormal operation of sensor, from the range of operation of the sensor, based on the inputs received from a user of the system. Further, the system may define a frequency of normal operation of the sensor, and a frequency of abnormal operation of the sensor, from the frequency of operation of the sensor, based on the inputs received from the user of the system. Further, the system is configured for generating, a first test data and a second test data. The first test data is generated by randomly selecting values between the range of normal operation of the sensor and the second test data is generated by randomly selecting values between the range of abnormal operation of the sensor. Further, the system is configured for accepting a set of test scenarios for testing the IOT network. Furthermore, the system is configured for generating master test data for testing the IOT network, wherein the master test data comprises a set of test packages corresponding to the set of test scenario. In one embodiment, each test package is generated by selecting values from the first test data and the second test data, based on the frequency of normal operation of the sensor and the frequency of abnormal operation of the sensor respectively corresponding to the test scenario.

While aspects of described system and method for testing an Internet of Things (IOT) network may be implemented in any number of different computing systems, environments, and/or configurations, the embodiments are described in the context of the following exemplary system.

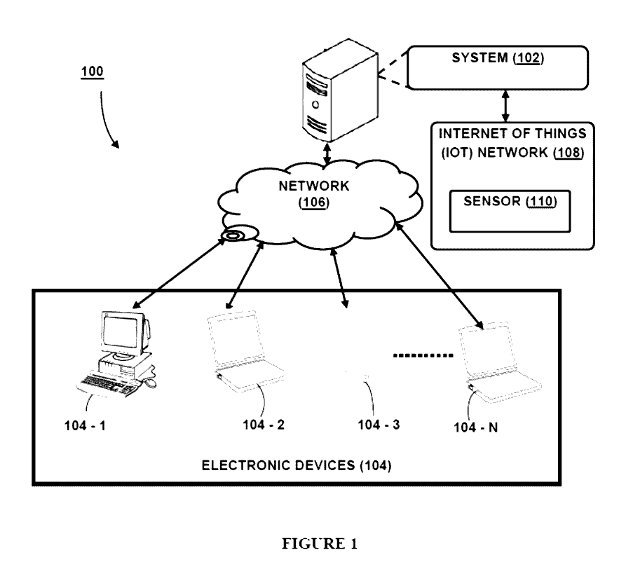

Referring now to FIG. 1, a network implementation 100 of a system 102 for testing an Internet of Things (IOT) network is disclosed. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented in a cloud-based environment. It will be understood that the system 102 may be accessed by multiple users through one or more user devices 104-1, 104-2 . . . 104-N, collectively referred to as user devices 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106. Further, the system 102 is connected to an Internet of Things(IOT) network 108 under simulation and testing. The IOT network 108 under simulation may be connected to at least one smart device with a dummy sensor hereafter referred to as sensor 110. The system 102 is configured to capture and maintains information of the sensor 110 attached to the smart device in the IOT network 108.

In one embodiment, the smart device may be a collection of sub-devices or sensors having different functions (Events, Commands). The smart device may comprise physical and observable characteristics in normal range of operation and abnormal range of operation. The functions of the smart device may include triggering event based on some condition/state. Further, the smart device may be configured to receive commands from external system for executing some procedure on smart device. Further, the sensor 110 may be assigned additional characteristics such as name, type, value, max-min range, unit of measurement and the like.

In one embodiment, the process of generating test data using the sensor 110 is initiated by capturing and analyzing the sensor ontology data of the sensor 110 to be simulated for testing an Internet of things (IOT) network 108. The sensor ontology data may include a range of operation of the sensor and a frequency of operation of the sensor. The system may define a range of normal operation of sensor and a range of abnormal operation of sensor, from the range of operation of the sensor, based on the inputs received from the user of the system. Further, the system may define a frequency of normal operation of the sensor, and a frequency of abnormal operation of the sensor, from the frequency of operation of the sensor, based on the inputs received from the user of the system. The sensor ontology data may also include type of sensor, event information to trigger the sensor, and sensor action. This sensor ontology data may be used to automated data generation for the smart device. The ontology information is extended with an application to generate data for different component of the smart device using fuzzy logic.

In one embodiment, the system 102 may enable a sensor ontology reader configured to read and parse the device/sensor ontology data and extracts information like attached sensors, event information, device action, sensor data attributes (minimum and maximum value), frequency of data generation and the like. In one embodiment, the ontology for the smart device is created and saved as RDF/OWL file which may be read and parsed by the test data generation module. The ontology may be in the form of profile or configurable parameters, wherein configurable parameters can be saved for future reference. Once the configurable parameters or profile is ready, test data generation process is started.

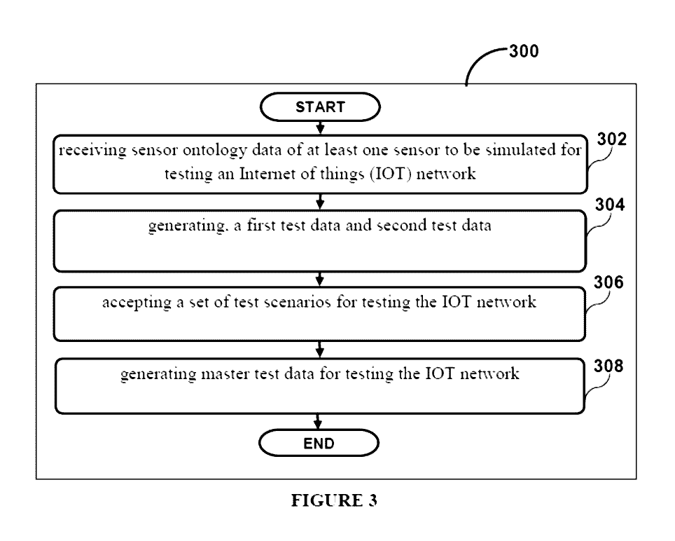

Further, the system 102 may enable a test data generation application for test data generation. The process of test data generation is further explained with reference to the flowchart of FIG. 3. Further, the system 102 may be configured to enable a test data profile creation module for generating a profile of the smart device, wherein the profile is generated by a test data generation fuzzy logic or historical sensor data.

In one embodiment, the sensor ontology data may be used for generating test data based on SSN sensor ontology data to simulate hardware device using fuzzy logic. For this purpose, in the first step, the system 102 is configured to select device ontology file (RDF/OWL) of the device/sensor under testing. Further, the ontology RDF/OWL file is read and parsed to extract information like attached sensors, event information, device action, the sensors data attributes (minimum and maximum values), frequency of data generation and the like. Once the sensor ontology data is read, parsed and visualized, the parameters for test data generation can further be configured using UI and saved for future reference.

In one embodiment, the system 102 is configured to generate test data based on historical sensor data. In the first step, the ontology RDF/OWL file is read and parsed to extract information like attached sensors, event information, device action, the sensors data attributes (minimum and maximum values), frequency of data generation etc. After extracting the information, the system 102 enables visualizing the information onto the User Interface(UI). Further, the test data may be configured using historical sensor data stored in the CSV file, database file and the like. Once ontology is read, parsed and visualized, the parameters for test data generation can further be configured using UI and saved for future reference. The test data generation configurable parameters may be saved for future reference.

In one embodiment, test data may be generated using a saved profile of the smart device/sensors. Initially the system may prompt the user to select the profile for test data generation. Once the profile is selected by the user, and the data upload timer event is occurred, then the test data is generated based on the data source (history data or fuzzy logic) selected by the user. If the data source selected by the user is fuzzy logic, then a random normal/abnormal data values are generated in the configured proportion and updated in memory. If the data source selected by user is history data, then the system 102 reads from the device data. This read data is then calibrated to generate a master test data for testing the IOT network 108.

In one embodiment, fuzzy logic is used by the system 102 for test data generation. There may be various sensors in the IOT network, wherein each sensor further has various properties. Initially, the system 102 is configured to generate an ontology file for the sensors/smart devices in the IOT network 108 to generate the test data profile by setting the range of normal operation of sensor and the range of abnormal operation of sensors. Further, the test data profile file may be stored as txt file or database. This test data file is then read and parsed to extract following parameters:
Sensor List
properties of each sensor
Normal range of operation for each sensor
Abnormal range of operation for each sensor
Normal data occurrence in percentage
Frequency to data transmission
Type of the sensor

Once the above information is extracted, random data is generated in normal/abnormal range. This test data is then stored as master test data and used in order to test the IOT network.

In one embodiment, the system 102 is further configured to generate test data based on defined set of rules and computational intelligence. This system 102 is also configured to define rules to generate sensor data in normal behavior and abnormal behavior conditions and also generate normal and failure events. This system also provides a method to define the frequency to send data to IoT/Centralized server over network. System also provides a method to map sensor and event data with device historical data to generate more realistic data. In one embodiment, the system 102 and the IOT network 108 may be connected thought the network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

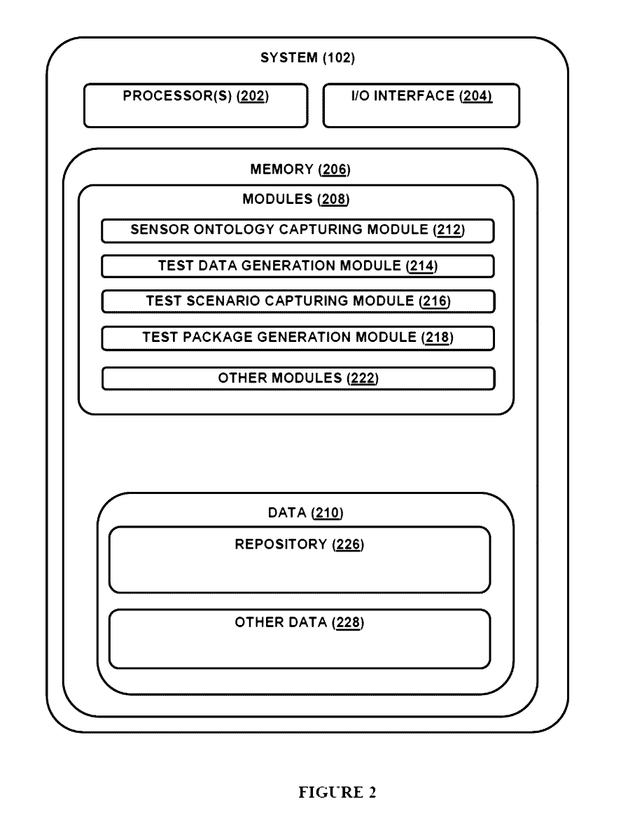

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks, functions or implement particular abstract data types. In one implementation, the modules 208 may include a sensor ontology capturing module 212, a test data generation module 214, a test scenario capturing module 216, a test package generation module 218, and other modules 222. The other modules 222 may include programs or coded instructions that supplement applications and functions of the system 102.

The data 210, amongst other things, serves as a repository for storing data processed, received, and generated by one or more of the modules 208. The data 210 may also include a repository 226, and other data 228. In one embodiment, the repository 226 may be configured to store a master test data. The master test data is configured to test the IOT network 108. In one embodiment, the other data 228 may include data generated as a result of the execution of one or more modules in the other module 222.

In one implementation, the process of test data generation is initiated by the sensor ontology capturing module 212. The sensor ontology capturing module 212 is configured for receiving sensor ontology data of at least one sensor 110 in the IOT network 108. The sensor ontology data may be generated at the time of simulating the IOT network 108. The sensor ontology data may include the range of operation of the sensor and the frequency of operation of the sensor. The sensor ontology capturing module 212 may further define a range of normal operation of sensor and a range of abnormal operation of sensor, from the range of operation of the sensor, based on the inputs received from a user of the system. Further, the sensor ontology capturing module 212 may further define a frequency of normal operation of the sensor, and a frequency of abnormal operation of the sensor, from the frequency of operation of the sensor, based on the inputs received from the user of the system.

In one example, the range of operation of a temperature sensor may be from 0 to 100 and the frequency of operation of the sensor may be between 30 and 90 signals/min. The sensor ontology capturing module 212 may accept user inputs and define the range of normal operation of sensor from 0 to 60 and the range of abnormal operation of sensor from 61 to 100. In a similar manner sensor ontology capturing module 212 may accept user inputs and define the range of frequency of normal operation of the sensor from 30 to 60 signals/min and the frequency of abnormal operation of the sensor from 61 to 90 signals/min.

In one embodiment, the sensor ontology data may further include historical sensor data. The historical sensor data may further be used to determine the frequency of normal operation of the sensor and frequency of abnormal operation of the sensor for each test scenario. Further, the frequency of signal generation of the sensor 110 also used to test the IOT network.

Once the sensor ontology data is captured, in the next step, the test data generation module 214 is configured for generating, a first test data and a second test data. The first test data is generated by randomly selecting values between the range of normal operation of the sensor and the second test data is generated by randomly selecting values between the range of abnormal operation of the sensor. In other words, the first test data comprises all the sensor values generated by the sensor in a normal range of operation, whereas second test data comprises all the sensor values generated by the sensor in an abnormal range of operation.

Further, the test scenario capturing module 216 is configured for accepting a set of test scenarios for testing the IOT network 108. The set of test scenarios may be defined by the user of the system 102. The different test scenarios may include load testing, failure testing, efficiency testing, and event based testing. For each test scenario, there may be a different combination of first test data and second test data required for testing the IOT network 108 for that particular scenario.

This different combination of test data for different test scenarios is captured the test package generation module 218. The test package generation module 218 is configured for generating master test data 226 for testing the IOT network 110. The master test data 226 comprises a set of test packages corresponding to the set of test scenario. Each test package for a test scenario is generated by selecting values from the first test data and the second test data, based on the frequency of normal operation of the sensor and the frequency of abnormal operation of the sensor respectively corresponding to the test scenario. Once the master test data is generated, in the next step, the master test data is stored in the repository 226. The method for generating the master test data is further illustrated with respect to the block diagram of FIG. 3.

Referring now to FIG. 3, a method 300 for testing an Internet of Things (IOT) network is disclosed, in accordance with an embodiment of the present subject matter. The method 300 may be described in the general context of computer executable instructions. Generally, computer executable instructions can include routines, programs, objects, components, data structures, procedures, modules, functions, and the like, that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method 300 can be implemented in any suitable hardware, software, firmware, or combination thereof. However, for ease of explanation, in the embodiments described below, the method 300 may be considered to be implemented in the above described system 102.

At block 302, the process of test data generation is initiated by the sensor ontology capturing module 212. The sensor ontology capturing module 212 is configured for receiving sensor ontology data of at least one sensor 110 in the IOT network 108. The sensor ontology data may be generated at the time of simulating the IOT network 108. The sensor ontology data may include a range of operation of the sensor and a frequency of operation of the sensor. The ontology capturing module 212 may define a range of normal operation of sensor and a range of abnormal operation of sensor, from the range of operation of the sensor, based on the inputs received from a user of the system. Further, the ontology capturing module 212 may define a frequency of normal operation of the sensor, and a frequency of abnormal operation of the sensor, from the frequency of operation of the sensor, based on the inputs received from the user of the system. In one embodiment, the sensor ontology data further includes historical sensor data. The historical sensor data may further be used to determine the frequency of normal operation of the sensor and frequency of abnormal operation of the sensor for each test scenario. Further, the frequency of signal generation of the sensor 110 also used to test the IOT network.

At block 304, once the sensor ontology data is captured, in the next step, the test data generation module 214 is configured for generating, a first test data and a second test data. The first test data is generated by randomly selecting values between the range of normal operation of the sensor and the second test data is generated by randomly selecting values between the range of abnormal operation of the sensor. In other words, the first test data comprises all the sensor values generated by the sensor in a normal range of operation, whereas second test data comprises all the sensor values generated by the sensor in an abnormal range of operation.

At block 306, the test scenario capturing module 216 is configured for accepting a set of test scenarios for testing the IOT network 108. The set of test scenarios may be defined by the user of the system 102. The different test scenarios may include load testing, failure testing, efficiency testing, and event based testing. For each test scenario, there may be a different combination of first test data and second test data required for testing the IOT network 108 for that particular scenario.

At block 308, the different combination of test data for different test scenarios is captured the test package generation module 218. The test package generation module 218 is configured for generating master test data 226 for testing the IOT network 110. The master test data 226 comprises a set of test packages corresponding to the set of test scenario. Each test package for a test scenario is generated by selecting values from the first test data and the second test data, based on the frequency of normal operation of the sensor and the frequency of abnormal operation of the sensor respectively corresponding to the test scenario. Once the master test data is generated, in the next step, the master test data is stored in the repository 226.

Although implementations for methods and systems for enabling testing an Internet of Things (IOT) network has been described, it is to be understood that the appended claims are not necessarily limited to the specific features or methods described. Rather, the specific features and methods are disclosed as examples of implementations for testing an Internet of Things (IOT) network.

We claim:

1. A system for generating test data for testing an Internet of Things (IOT) network, the system comprising:
a memory; and
a processor coupled to the memory, wherein the processor is configured to execute program instructions stored in the memory for:
receiving sensor ontology data of at least one sensor to be simulated for testing an Internet of things (IOT) network, wherein the sensor ontology data includes a range of operation of the sensor and a frequency of operation of the sensor;
defining,
a range of normal operation of sensor and a range of abnormal operation of sensor from the range of operation, and
a frequency of normal operation of the sensor, and a frequency of abnormal operation of the sensor from the frequency of operation; generating,
a first test data based on the range of normal operation, wherein the first data is generated by randomly selecting values between the range of normal operation of the sensor, and
a second test data based on the range of abnormal operation, wherein the second data is generated by randomly selecting values between the range of abnormal operation of the sensor;
accepting a set of test scenarios for testing the IOT network; and
generating master test data for testing the IOT network, wherein the master test data comprises a set of test packages corresponding to the set of test scenario, wherein each test package is generated by selecting values from the first test data and the second test data, based on the frequency of normal operation of the sensor and the frequency of abnormal operation of the sensor respectively corresponding to the test scenario.

2. The system of claim 1, wherein the sensor ontology data further includes historical sensor data.

3. The system of claim 2, wherein historical sensor data is used to determine the frequency of normal operation of the sensor and frequency of abnormal operation of the sensor for each test scenario, and wherein the frequency of signal generation of the sensor is used to test the IOT network.

4. The system of claim 1, wherein the set of test scenarios include load testing, failure testing, efficiency testing, and event based testing.

5. A method for generating test data for testing an Internet of Things (IOT) network, the method comprising steps of:
receiving, by a processor, sensor ontology data of at least one sensor to be simulated for testing an Internet of things (IOT) network, wherein the sensor ontology data includes a range of operation of the sensor and a frequency of operation of the sensor;
defining, by the processor,
a range of normal operation of sensor and a range of abnormal operation of sensor from the range of operation, and
a frequency of normal operation of the sensor, and a frequency of abnormal operation of the sensor from the frequency of operation;
generating, by the processor,
a first test data based on the range of normal operation, wherein the first data is generated by randomly selecting values between the range of normal operation of the sensor, and
a second test data based on the range of abnormal operation, wherein the second data is generated by randomly selecting values between the range of abnormal operation of the sensor;
accepting by the processor, a set of test scenarios for testing the IOT network; and
generating, by the processor, master test data for testing the IOT network, wherein the master test data comprises a set of test packages corresponding to the set of test scenario, wherein each test package is generated by selecting values from the first test data and the second test data, based on the frequency of normal operation of the sensor and the frequency of abnormal operation of the sensor respectively corresponding to the test scenario.

6. The method of claim 5, wherein the sensor ontology data further includes historical sensor data.

7. The method of claim 6, wherein historical sensor data is used to determine the frequency of normal operation of the sensor and frequency of abnormal operation of the sensor for each test scenario, and wherein the frequency of signal generation of the sensor is used to test the IOT network.

8. The system of claim 5, wherein the set of test scenarios include load testing, failure testing, efficiency testing, and event based testing.

9. A non-transitory computer readable medium embodying a program executable in a computing device for testing an Internet of Things (IOT) network, the computer program product comprising:
a program code for receiving sensor ontology data of at least one sensor to be simulated for testing an Internet of things (IOT) network, wherein the sensor ontology data includes a range of operation of the sensor and a frequency of operation of the sensor;
a program code for defining,
a range of normal operation of sensor and a range of abnormal operation of sensor from the range of operation, and
a frequency of normal operation of the sensor, and a frequency of abnormal operation of the sensor from the frequency of operation;
a program code for generating,
a first test data based on the range of normal operation, wherein the first data is generated by randomly selecting values between the range of normal operation of the sensor, and
a second test data based on the range of abnormal operation, wherein the second data is generated by randomly selecting values between the range of abnormal operation of the sensor;
a program code for accepting a set of test scenarios for testing the IOT network; and
a program code for generating master test data for testing the IOT network, wherein the master test data comprises a set of test packages corresponding to the set of test scenario, wherein each test package is generated by selecting values from the first test data and the second test data, based on the frequency of normal operation of the sensor and the frequency of abnormal operation of the sensor respectively corresponding to the test scenario.
